(19) United States
(12) Patent Application Publication
(10) Pub. No.: US 2014/0112636 A1
(43) Pub. Date: Apr. 24, 2014

(54) Video Playback System and Related Method of Sharing Video from a Source Device on a Wireless Display

(71) Applicant: ARCSOFT HANGZHOU CO., LTD., Hangzhou City (CN)

(72) Inventors: Jin Huang, Hangzhou City (CN); Chung-Yang Lin, Hangzhou City (CN); HongYan Zhao, Hangzhou City (CN)

(73) Assignee: ARCSOFT HANGZHOU CO., LTD., Hangzhou City (CN)

(21) Appl. No.: 13/655,445

(22) Filed: Oct. 19, 2012

(51) Int. Cl. H04N 5/775

(52) U.S. Cl. 386/230; 386/E05.07

(57) ABSTRACT

A method of using a source device to control playback of a video file on a wireless display is disclosed. The method includes determining, with the source device, that the video file conforms to Moving Picture Experts Group (MPEG) transport stream and H.264 video format standards, wherein the video file is created without capturing contents of a screen of the source device, wirelessly transmitting the video file from the source device to the wireless display, and playing the video file on the wireless display while controlling playback using the source device.

### BACKGROUND OF THE INVENTION

1. Field of the Invention

The invention relates to a wireless video playback system, and more particularly to a video playback system for using a source device to control playback of a video file on a wireless display.

2. Description of the Prior Art

Wi-Fi Displays are wireless displays that allow users to transmit video content from a source device to the Wi-Fi Display for playback. In this way a user can watch the video content on a Wi-Fi Display that is more suitable for the user's purpose than a display of the source device. For instance, suppose the user wishes to share a video from a notebook computer to a large screen television so that multiple people can comfortably watch the video on the television together. In this example, the notebook computer is the source device and the television is the Wi-Fi Display (assuming the television supports Wi-Fi Display specifications), and the source device transmits video content to the Wi-Fi Display for playback on the Wi-Fi Display.

Please refer to FIG. 1. FIG. 1 is a block diagram of a video playback system 10 according to the prior art. The video playback system 10 contains a source device 12 and a Wi-Fi Display 14. Video content is transmitted from the source device 12 to the Wi-Fi Display 14 using Real-time Transport Protocol (RTP) streaming.

Unfortunately, prior art methods of sharing video content from the source device 12 to the Wi-Fi Display 14 require the Wi-Fi Display 14 to act as a mirror of what is shown on a screen of the source device 12. Because of this, numerous steps must be performed for mirroring the video content shown on the screen of the source device 12 on the Wi-Fi Display 14.

Please refer to FIG. 2. FIG. 2 is a flowchart describing the prior art method of mirroring the screen of the source device 12 on the Wi-Fi Display 14. Steps in the flowchart will be explained as follows.

Step 20: Video content to be shown on the source device 12 must first be decoded.

Step 22: The decoded data is rendered to produce the video data shown on the screen of the source device 12.

Step 24: A screen capture process is performed for capturing the video data stored on the screen of the source device 12.

Step 26: The captured video data is then encoded into the H.264 video format, which is necessary for compatibility with the Wi-Fi Display 14.

Step 28: The encoded video data is multiplexed into a Moving Picture Experts Group (MPEG) transport stream format, which is also necessary for compatibility with the Wi-Fi Display 14.

Step 30: The multiplexed video data is wirelessly transmitted to the Wi-Fi Display 14 using RTP streaming, and the video data shown on the screen of the source device 12 is mirrored on the Wi-Fi Display 14.

Unfortunately, as seen in the flowchart of FIG. 2, there are numerous steps that must be performed before the video content shown on the screen of the source device 12 can be mirrored on the Wi-Fi Display 14. The video content must first be decoded and rendered for showing on the screen. Then the video content shown on the screen must be captured, encoded, and multiplexed before it is transmitted to the Wi-Fi Display 14. In addition, users are limited to using the Wi-Fi Display 14 as a mirror of the screen of the source device 12, and cannot show different data on the Wi-Fi Display 14 than what is being shown on the screen of the source device 12. Moreover, the numerous steps involved for outputting video content from the source device 12 to the Wi-Fi Display 14 may lead to quality loss and degradation in video signals. Consequently, there exists a need for an improved method of outputting video content to a Wi-Fi Display.

### SUMMARY OF THE INVENTION

It is therefore one of the primary objectives of the claimed invention to provide an improved method and video system for outputting video content from a source device to a wireless display such as a Wi-Fi Display.

According to an exemplary embodiment of the claimed invention, a method of using a source device to control playback of a video file on a wireless display is disclosed. The method includes determining, with the source device, that the video file conforms to Moving Picture Experts Group (MPEG) transport stream and H.264 video format standards, wherein the video file is created without capturing contents of a screen of the source device, wirelessly transmitting the video file from the source device to the wireless display, and playing the video file on the wireless display while controlling playback using the source device.

According to another exemplary embodiment of the claimed invention, a video playback system includes a source device analyzing a video file and determining that the video file conforms to Moving Picture Experts Group (MPEG) transport stream and H.264 video format standards, wherein the video file is created without capturing contents of a screen of the source device, a wireless display wirelessly receiving the video file from the source device and playing the video file on the wireless display, wherein the source device controls playback of the video file on the wireless display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a video playback system 10 according to the prior art.

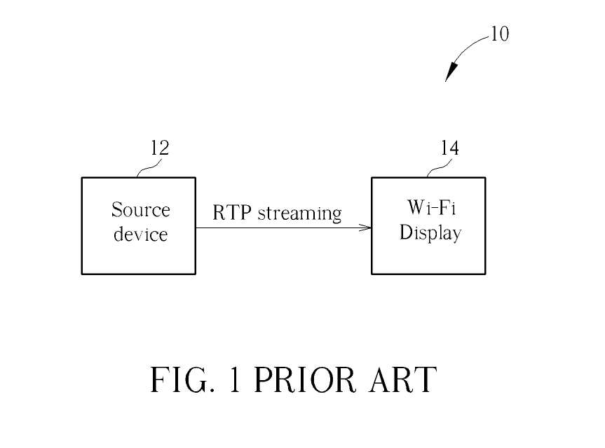

FIG. 2 is a flowchart describing the prior art method of mirroring a screen of a source device on a Wi-Fi Display.

FIG. 3 is a block diagram of a video playback system according to the present invention.

FIG. 4 is a flowchart describing the process of first analyzing the format of the video file to be transmitted from the source device to the Wi-Fi Display.

FIG. 5 is a continuation of the flowchart of FIG. 4 showing the steps involved with transmitting the video file from the source device to the Wi-Fi Display when the format of the video file meets a first condition.

FIG. 6 is a continuation of the flowchart of FIG. 4 showing the steps involved with transmitting the video file from the source device to the Wi-Fi Display when the format of the video file meets a second condition.

FIG. 7 is a continuation of the flowchart of FIG. 4 showing the steps involved with transmitting the video file from the source device to the Wi-Fi Display when the format of the video file meets a third condition.

### DETAILED DESCRIPTION

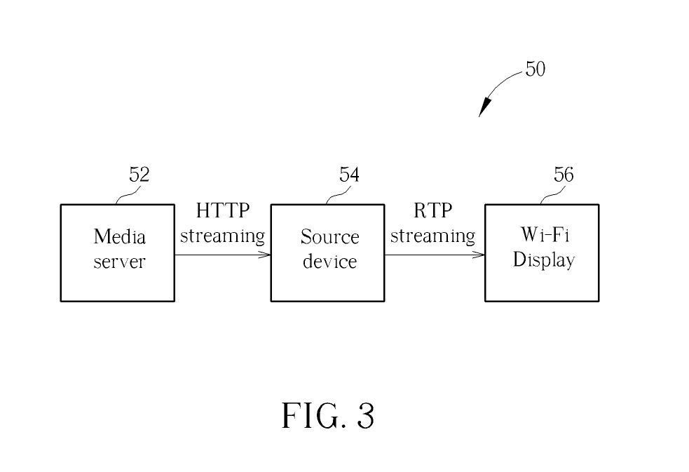

Please refer to FIG. 3. FIG. 3 is a block diagram of a video playback system 50 according to the present invention. The video playback system 50 contains a media server 52, a source device 54, and a Wi-Fi Display 56. In the present invention, the source device 54 uses the Wi-Fi Display 56 as a virtual display of the source device 54. That is, what is shown on the Wi-Fi Display 56 does not need to mirror what is shown on the screen of the source device 54. Instead, the source device 54 can use the Wi-Fi Display 56 as a second screen. The first screen, which is the actual screen of the source device 54, can serve as a control interface for controlling playback of a video file on the Wi-Fi Display 56 and can also be used for other normal computing functions performed by the user of the source device 54. The second screen, which is the Wi-Fi Display 56, is used for playing the video file that is sent from the source device 54 to the Wi-Fi Display 56. By eliminating the need for the Wi-Fi Display 56 to mirror what is shown on the screen of the source device 54, the present invention provides a simpler and more flexible way to share videos on the Wi-Fi Display 56 using the source device 54. The Wi-Fi Display 56 may be a television, a set top box, or any other device that supports the Wi-Fi Display specifications.

A video file is optionally wirelessly transmitted from the media server 52 to the source device 54 using Hypertext Transfer Protocol (HTTP) streaming. Variants of HTTP streaming, such as sending the network file using DLNA (Digital Living Network Alliance) protocol standards, can also be used for sending the video file from the media server 52 to the source device 54. Alternatively, the video file may be provided by the source device 54 itself, thereby eliminating the need for the source device 54 to receive the video file from the media server 52.

In the present invention, the source device 54 determines if the video file to be played on the Wi-Fi Display 56 is already in the proper format for the Wi-Fi Display 56, and converts the video file if it needs converting. The Wi-Fi Display 56 can play video files that are in the H.264 video format and which have been encapsulated into the MPEG transport stream format. Video files that are not already in this format will need to be converted by the source device 54 before the video files are wirelessly transmitted from the source device 54 to the Wi-Fi Display 56 using RTP streaming. The audio format of audio contained in the video file may be an audio format standard such as AC-3, Advanced Audio Coding (AAC), or Linear pulse-code modulation (LPCM).

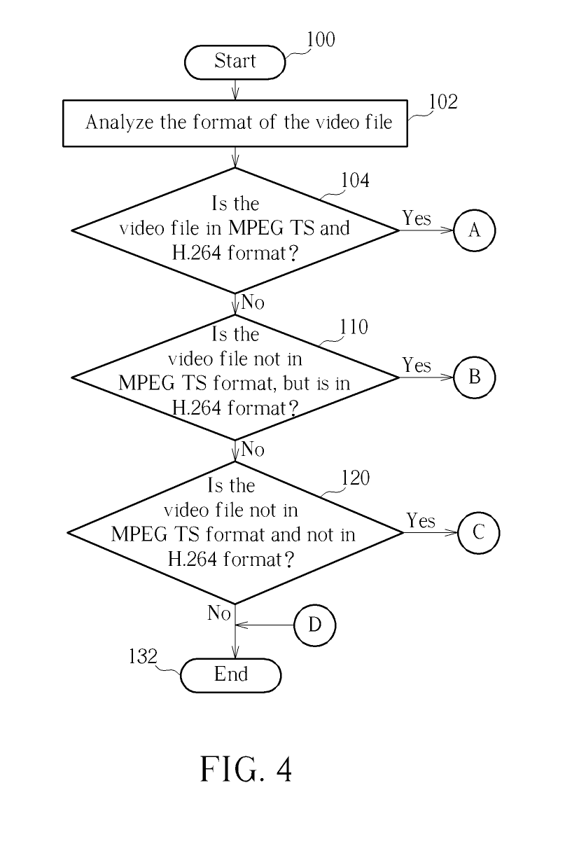

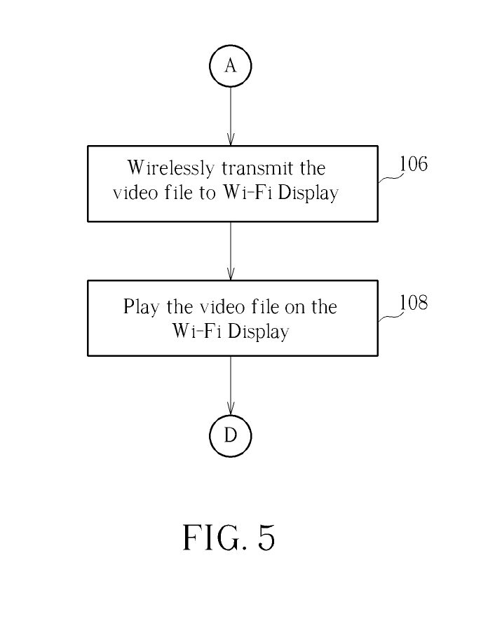

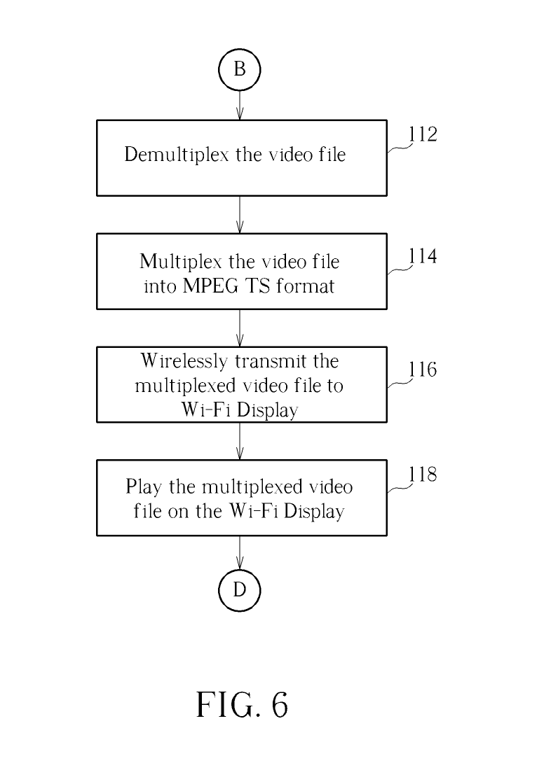

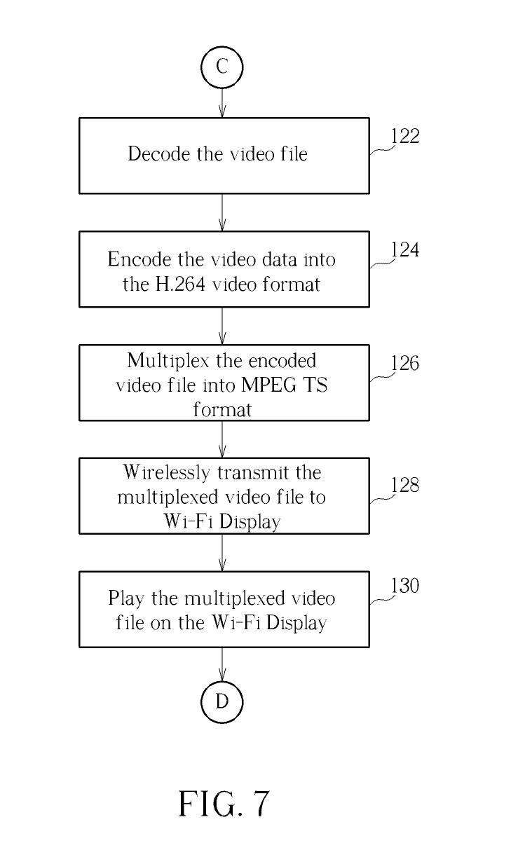

Please refer to FIGS. 4-7. FIG. 4 is a flowchart describing the process of first analyzing the format of the video file to be transmitted from the source device 54 to the Wi-Fi Display 56. FIG. 5 is a continuation of the flowchart of FIG. 4 showing the steps involved with transmitting the video file from the source device 54 to the Wi-Fi Display 56 when the format of the video file meets a first condition. FIG. 6 is a continuation of the flowchart of FIG. 4 showing the steps involved with transmitting the video file from the source device 54 to the Wi-Fi Display 56 when the format of the video file meets a second condition. FIG. 7 is a continuation of the flowchart of FIG. 4 showing the steps involved with transmitting the video file from the source device 54 to the Wi-Fi Display 56 when the format of the video file meets a third condition. Steps in the flowcharts of FIGS. 4-7 will be explained as follows.

Step 100: Start.

Step 102: Use the source device 54 to analyze the format of the video file to be played on the Wi-Fi Display 56. The video file may already reside on the source device 54 or may be received from the media server 52 using HTTP streaming.

Step 104: Determine if the video file to be played conforms to both the MPEG transport stream video format standard and the H.264 video format standard. If this condition is satisfied, go to step 106. If not, go to step 110.

Step 106: Since the video file is already in the proper format for being played on the Wi-Fi Display 56, the source device 54 can immediately start to wirelessly transmit the video file to the Wi-Fi Display 56 using RTP streaming.

Step 108: The source device 54 uses the Wi-Fi Display 56 as a virtual display for playing the video file, and the screen of the source device 54 is used to control playback of the video file as well as to perform other computing functions. After the video file is played, go to step 132.

Step 110: Determine if the video file to be played does not conform the MPEG transport stream video format standard but does conform to the H.264 video format standard. If this condition is satisfied, go to step 112. If not, go to step 120.

Step 112: Demultiplex the video file into separate audio and video components.

Step 114: The demultiplexed audio and video components are multiplexed into the Moving Picture Experts Group (MPEG) transport stream format. Since the video component is already in the H.264 video format, the video component does not need to be re-encoded into the H.264 video format. The only action that is necessary is to encapsulate the audio component and the video component into the MPEG transport stream format through a simple multiplexing step to produce a multiplexed video file.

Step 116: Since the multiplexed video file is now in the proper format for being played on the Wi-Fi Display 56, the source device 54 can immediately start to wirelessly transmit the multiplexed video file to the Wi-Fi Display 56 using RTP streaming.

Step 118: The source device 54 uses the Wi-Fi Display 56 as a virtual display for playing the multiplexed video file, and the screen of the source device 54 is used to control playback of the multiplexed video file as well as to perform other computing functions. After the multiplexed video file is played, go to step 132.

Step 120: Determine if the video file to be played does not conform the MPEG transport stream video format standard and also does not conform to the H.264 video format standard. If this condition is satisfied, go to step 122. If not, go to step 132.

Step 122: Decode the video file to separate the video file into separate audio and video components and to decode the video component into video data.

Step 124: Encode the video data to encode the decoded video data into the H.264 video format.

Step 126: Multiplex the audio component and the encoded video component into the Moving Picture Experts Group (MPEG) transport stream format. The encoded video component is now in the H.264 video format, so the audio component and the encoded video component are encapsulated into the MPEG transport stream format through a multiplexing step to produce a multiplexed video file.

Step 128: Since the multiplexed video file is now in the proper format for being played on the Wi-Fi Display 56, the source device 54 can immediately start to wirelessly transmit the multiplexed video file to the Wi-Fi Display 56 using RTP streaming.

Step 130: The source device 54 uses the Wi-Fi Display 56 as a virtual display for playing the multiplexed video file, and the screen of the source device 54 is used to control playback of the multiplexed video file as well as to perform other computing functions.

Step 132: End.

As can be seen, the source device 54 needs to determine if the video file to be played on the Wi-Fi Display 56 conforms to both the MPEG transport stream video format standard and the H.264 video format standard. If the video file is not in the correct format, the source device 54 converts the video file to the correct format. Once the video file is in the correct format, the video file can be wirelessly transmitted to the Wi-Fi Display 56 using RTP streaming for video playback.

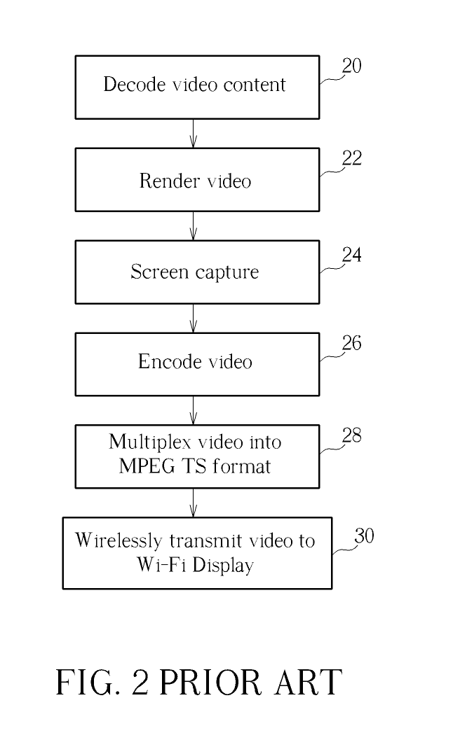

Differing from the prior art method of playing video files from a source device on a Wi-Fi Display, the present invention avoids the need for the Wi-Fi Display 56 to mirror the screen of the source device 54. Consequently, it is not necessary to execute the computationally intensive steps shown in the flowchart of FIG. 2 in order to perform the screen capture process for sending a copy of what is shown on the screen of the source device 54 to the Wi-Fi Display 56. Thus, there is less burden placed on the source device 54 when outputting video to the Wi-Fi Display 56 using the present invention method than there is in the prior art method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of using a source device to control playback of a video file on a wireless display, the method comprising:
determining, with the source device, that the video file conforms to Moving Picture Experts Group (MPEG) transport stream and H.264 video format standards, wherein the video file is created without capturing contents of a screen of the source device;
wirelessly transmitting the video file from the source device to the wireless display; and
playing the video file on the wireless display while controlling playback using the source device.

2. The method of claim 1 further comprising:
determining, with the source device, that the video file does not conform to the MPEG transport stream video format standard and does conform to the H.264 video format standard;
demultiplexing the video file;
multiplexing the demultiplexed video file to convert the demultiplexed video file such that the multiplexed video file conforms to the MPEG transport stream video format standard in addition to the H.264 video format standard, wherein the multiplexed video file is created without capturing contents of the screen of the source device;
wirelessly transmitting the multiplexed video file from the source device to the wireless display; and
playing the multiplexed video file on the wireless display while controlling playback using the source device.

3. The method of claim 1 further comprising:
determining, with the source device, that the video file does not conform to the MPEG transport stream video format standard and does not conform to the H.264 video format standard;
decoding the video file;
encoding the decoded video file to convert the decoded video file to conform to the H.264 video format standard;
multiplexing the encoded video file to convert the encoded video file such that the multiplexed video file conforms to the MPEG transport stream video format standard in addition to the H.264 video format standard, wherein the multiplexed video file is created without capturing contents of the screen of the source device;
wirelessly transmitting the multiplexed video file from the source device to the wireless display; and
playing the multiplexed video file on the wireless display while controlling playback using the source device.

4. The method of claim 1, further comprising the source device receiving the video file from a media server through Hypertext Transfer Protocol (HTTP) streaming.

5. The method of claim 1, wherein the wireless display is a Wi-Fi Display.

6. The method of claim 1, wherein wirelessly transmitting the video file from the source device to the wireless display is performed using Real-time Transport Protocol (RTP) streaming.

7. The method of claim 1, wherein the video file wirelessly transmitted from the source device to the wireless display has an audio format conforming to a standard selected from AC-3, Advanced Audio Coding (AAC), or Linear pulse-code modulation (LPCM) audio format standards.

8. The method of claim 1, wherein the wireless display serves as a virtual display of the source device and does not mirror the screen of the source device.

9. The method of claim 1, wherein the video file is not displayed on the screen of the source device, the wireless display serves as a virtual display of the source device, and the screen of the source device serves as a control interface for controlling playback of the video file on the wireless display.

10. A video playback system, comprising:
a source device analyzing a video file and determining that the video file conforms to Moving Picture Experts Group (MPEG) transport stream and H.264 video format standards, wherein the video file is created without capturing contents of a screen of the source device; and
a wireless display wirelessly receiving the video file from the source device and playing the video file on the wireless display, wherein the source device controls playback of the video file on the wireless display.

11. The video playback system of claim 10, wherein when the source device determines that the video file does not conform to the MPEG transport stream video format standard and does conform to the H.264 video format standard, the source device demultiplexes the video file, multiplexes the demultiplexed video file to convert the demultiplexed video file such that the multiplexed video file conforms to the MPEG transport stream video format standard in addition to the H.264 video format standard, wherein the multiplexed video file is created without capturing contents of the screen of the source device, wirelessly transmits the multiplexed video file from the source device to the wireless display, and controls playback of the multiplexed video file on the wireless display.

12. The video playback system of claim 10, wherein when the source device determines that the video file does not conform to the MPEG transport stream video format standard and does not conform to the H.264 video format standard, the source device decodes the video file, encodes the decoded video file to convert the decoded video file to conform to the H.264 video format standard, multiplexes the encoded video file to convert the encoded video file such that the multiplexed video file conforms to the MPEG transport stream video format standard in addition to the H.264 video format standard, wherein the multiplexed video file is created without capturing contents of the screen of the source device, wirelessly transmits the multiplexed video file from the source device to the wireless display, and controls playback of the multiplexed video file on the wireless display.

13. The video playback system of claim 10, further comprising a media server providing the source device with the video file through Hypertext Transfer Protocol (HTTP) streaming.

14. The video playback system of claim 10, wherein the wireless display is a Wi-Fi Display.

15. The video playback system of claim 10, wherein the wireless display wirelessly receives the video file from the source device using Real-time Transport Protocol (RTP) streaming.

16. The video playback system of claim 10, wherein the video file wirelessly received by the wireless display has an audio format conforming to a standard selected from AC-3, Advanced Audio Coding (AAC), or Linear pulse-code modulation (LPCM) audio format standards.

17. The video playback system of claim 10, wherein the wireless display serves as a virtual display of the source device and does not mirror the screen of the source device.

18. The video playback system of claim 10, wherein the video file is not displayed on the screen of the source device, the wireless display serves as a virtual display of the source device, and the screen of the source device serves as a control interface for controlling playback of the video file on the wireless display.
